(19) United States
(12) Patent Application Publication
(10) Pub. No.: US 2016/0180305 A1
(43) Pub. Date: Jun. 23, 2016

(54) Payment Method Linked To A Mobile Number

(71) Applicant: BC Investments & Leasing, Inc., Fargo, ND (US)

(72) Inventors: Craig S. Dresser, Fargo, ND (US); Bryan J. Smith, Fargo, ND (US)

(73) Assignee: BC Investments & Leasing, Inc.

(21) Appl. No.: 15/019,888

(22) Filed: Feb. 9, 2016

Related U.S. Application Data
(63) Continuation-in-part of application No. 14/472,971, filed on Aug. 29, 2014.
Application No. 14/472,971 is a continuation-in-part of application No. 13/658,079, filed on Oct. 23, 2012.
Application No. 13/658,079 is a continuation-in-part of application No. 14/489,106, filed on Sep. 17, 2014.
(60) Provisional application No. 61/871,694, filed on Aug. 29, 2013.
(60) Provisional application No. 61/550,634, filed on Oct. 24, 2011.
(60) Provisional application No. 61/878,750, filed on Sep. 17, 2013.
(60) Provisional application No. 62/113,877, filed on Feb. 9, 2015.

(51) Int. Cl. G06Q 20/10; G06Q 20/40; G06Q 20/32

(52) U.S. Cl. CPC G06Q 20/102; G06Q 20/3255; G06Q 20/401; G06Q 20/4012

(57) ABSTRACT

Embodiments related to payments linked to a mobile number are described herein. In an embodiment, a payment request is received from a payee device for a payment on behalf of payer. A mobile number associated with the payer is determined, and an authorization request for the payment is transmit to the mobile number. A payment authorization from a device associated with the mobile number is received. A transaction request is submit to a financial institution associated with the payer to make the payment to payee. The payer and payee are notified as to a result of the transaction request.

### CROSS REFERENCE TO RELATED APPLICATIONS

The present application is a continuation-in-part of U.S. application Ser. No. 14/472,971 filed on Aug. 29, 2014 (Docket No. INTE-044), which is a continuation-in-part of U.S. application Ser. No. 13/658,079 filed on Oct. 23, 2012 (Docket No. INTE-032) and claims priority to U.S. Provisional Application No. 61/871,694 filed Aug. 29, 2013 (Docket No. INTE-043), which claims priority to U.S. Provisional Application No. 61/550,634 filed Oct. 24, 2011 (Docket No. INTE-030).

The present application is also a continuation-in-part of U.S. application Ser. No. 14/489,106 filed on Sep. 17, 2014 (Docket No. INTE-046), which claims priority to U.S. Provisional Application No. 61/878,750 filed Sep. 17, 2013 (Docket No. INTE-045). Each of the aforementioned patent applications, and any applications related thereto, is herein incorporated by reference in their entirety.

I hereby claim benefit under Title 35, United States Code, Section 119(e) of U.S. provisional patent application Ser. No. 62/113,877 filed Feb. 9, 2015 (Docket No. INTE-047).

Each of the aforementioned patent applications, and any applications related thereto, herein incorporated by reference in their entirety.

### STATEMENT REGARDING FEDERALLY SPONSORED RESEARCH OR DEVELOPMENT

Not applicable to this application.

### BACKGROUND

A point of sales (POS) system processes the transactions that enable customers to purchase goods and services from a business. Delays or malfunctions with the POS system could cost the business money in missing additional revenue, resulting in lost sales, and customer dissatisfaction. Conversely, any improvement in a POS system could help improve business revenue, increase sales, and improve customer satisfaction.

1. Field

Example embodiments in general relate to a payment method linked to a mobile number.

2. Related Art

Any discussion of the related art throughout the specification should in no way be considered as an admission that such related art is widely known or forms part of common general knowledge in the field.

### SUMMARY

Described herein is a payment method linked to a mobile number. The system for linking payment to a mobile number generally relates to electronic payment systems and more specifically it relates to a payment method linked to a mobile number for allowing consumers to pay for goods and services with a mobile phone number.

Embodiments related to payments linked to a mobile number are described herein. In an embodiment, a payment request is received from a payee device for a payment on behalf of the payer. A mobile number associated with the payer is determined, and an authorization request for the payment is transmitted to the mobile number. A payment authorization from a device associated with the mobile number is received. A transaction request is submitted to a financial institution associated with the payer to make the payment to the payee. The payer and payee are notified as to a result of the transaction request.

In an embodiment, the system for linking payment to a mobile number enrolls a payer with a payee, verifies the payer information, sends an introductory message to the payer, receives an acceptance message from the payer, receives a request from the payee for a payer purchase, and authorizes a credit card transaction or creating an electronic funds transfer through the ACH network. The payment system may operate in an automated manner to ensure expedited processing of payments. Payments and messages may be processed utilizing a SMS (short messaging service) system with a mobile device and an application on the payee device that both communicate with the control center. The use of SMS alleviates the need for a smart phone to use a payment system.

A payment method may be linked to a mobile number for allowing consumers to pay for goods and services with a mobile phone number. Such a payment system may help reduce fraud in the marketplace by eliminating the need to carry a wallet, allowing customers to make purchases using only their cell phones or other devices.

There has thus been outlined, rather broadly, some of the features of a system for linking payment to a mobile number in order that the detailed description thereof may be better understood, and in order that the present contribution to the art may be better appreciated. There are additional features of the payment system that will be described hereinafter and that will form the subject matter of the claims appended hereto.

It is to be understood that the invention is not limited in its application to the details of construction, the arrangements of the components, or other exemplary embodiments set forth in the following description or illustrated in the drawings. The invention is capable of other embodiments and of being practiced and carried out in various ways. Also, it is to be understood that the phraseology and terminology employed herein are for the purpose of the description and should not be regarded as limiting.

Other objects and advantages of the present invention, beyond those described herein, will become obvious to the reader and it is intended that these objects and advantages are within the scope of the present invention. The invention may be embodied in the form illustrated in the accompanying drawings, attention being called to the fact, however, that the drawings are illustrative only, and that changes may be made in the specific construction illustrated and described within the scope of this application.

### BRIEF DESCRIPTION OF THE DRAWINGS

Example embodiments will become more fully understood from the detailed description given herein below and the accompanying drawings, wherein like elements are represented by like reference characters, which are given by way of illustration only and thus are not limitative of the example embodiments herein.

Various other objects, features and attendant advantages of the present invention will become fully appreciated as the same becomes better understood when considered in conjunction with the accompanying drawings, in which like reference characters designate the same or similar parts throughout the several views, and wherein:

FIG. 1 is a block diagram of a system for linking payments to a mobile number, according to an example embodiment.

FIG. 2 is a block diagram of a system for linking payments to a mobile number, according to another example embodiment.

FIG. 3 is a flowchart illustrating a payer enrollment with a payee, according to an example embodiment.

FIG. 4 is a flowchart illustrating a payer confirmation, according to an example embodiment.

FIG. 5 is a flowchart illustrating overall messaging of a system for linking payments to a mobile number, according to an example embodiment.

FIG. 6 is a flowchart illustrating a request for payment, according to an example embodiment.

FIG. 7 is an exemplary illustration of an introductory message, according to an example embodiment.

FIG. 8 is an exemplary illustration of an acceptance message, according to an example embodiment.

FIG. 9 is an exemplary illustration of a confirmation message, according to an example embodiment.

FIG. 10 is an exemplary illustration of a payment request message, according to an example embodiment.

FIG. 11 is an exemplary illustration of a CONFIRM message, according to an example embodiment.

FIG. 12 is an exemplary illustration of a confirmation to pay via a PIN, according to an example embodiment.

FIG. 13 is an exemplary illustration of a receipt of payment, according to an example embodiment.

FIG. 14 is a block diagram of a system for linking payments to a mobile number, according to an example embodiment.

FIG. 15 is an example swim-lane diagram illustrating example operations of a system for linking payments to a mobile number, according to an example embodiment.

### DETAILED DESCRIPTION

Turning now descriptively to the drawings, in which similar reference characters denote similar elements throughout the several views, the figures illustrate a system for linking payments to a mobile number according to various example embodiments. The figures show, for example, enrolling a payer 80 with a payee 70, verifying the payer 80 information, sending an introductory message to the payer 80, receiving an acceptance message from the payer 80, receiving a request from the payee 70 for a payer 80 purchase, authorizing a credit card transaction or creating an electronic funds transfer through the ACH or other financial network. The system for linking payment to a mobile number may create a link 150 between payer 80 and payee 70 enabling payments between the parties from their mobile devices 82 and 72. The system may be automated to ensure expedited processing of payments. It may also utilize a SMS system with a mobile device and an application on the payee device 72 that both communicate with the control center 20.

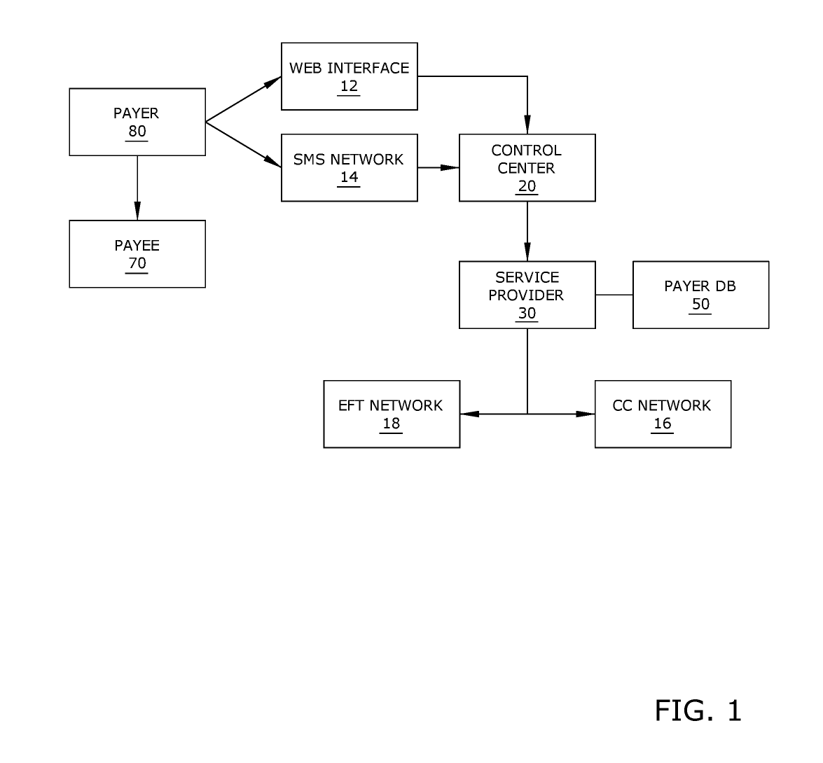

FIG. 1 is a block diagram of a system for linking payments to a mobile number, according to an example embodiment. The control center 20 controls the overall process for linking payment to a mobile number including receiving and sending text messages (including SMS messages) relating to a request for payment. In an embodiment, the control center 20 may be or otherwise operate with a financial institution (e.g., such as a bank, credit company, or other financial clearinghouse).

The control center 20 may be an entity separate from the service provider 30 thereby allowing for multiple service providers 30 to utilize the system controlled by the control center 20. In another embodiment, the control center 20 and the service provider 30 may be part of the same entity. For the purposes of discussion herein, the term control center 20 may be used interchangeably with service provider 30.

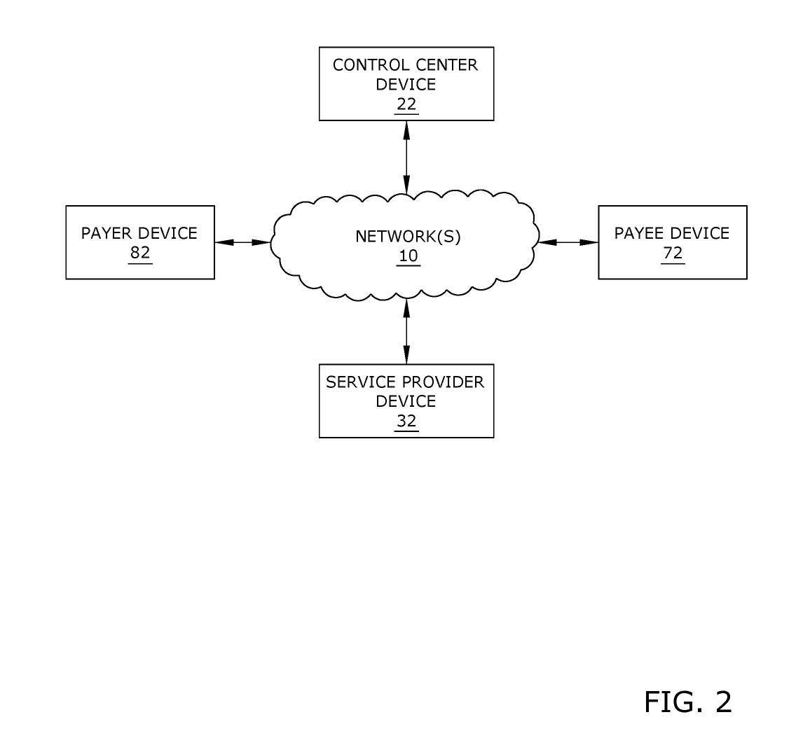

FIG. 2 is a block diagram of a system for linking payments to a mobile number, according to an example embodiment. As shown in FIG. 2, the system for linking payments to a mobile number may utilize any exemplary communications network(s) 10 capable of transmitting electronic data between a plurality of electronic devices (e.g., computers, mobile devices, etc.). The system may communicate via a single telecommunication network 10 or multiple telecommunication networks 10 concurrently. In particular, the payee device 72, the payer device 82, the service provider device 32, the control center device 22 and various other devices utilized within the present invention may communicate with one another via one or more networks 10.

As used herein, though differently enumerated, payee 70 and payee device 72 may at times be used interchangeably, as may control center 20 and control center device 22, service provider 30 and service provider device 32, and payer 80 and payer device 82. For example, receiving a payment request from a payee 70, may be understood that the payment request is being received from the payee device 72.

The mobile device may be any conventional computer that is portable. A conventional computer preferably includes a display screen (or monitor), a printer, a hard disk drive, a network interface, and a keyboard. A conventional computer also includes a microprocessor, a memory bus, random access memory (RAM), read only memory (ROM), a peripheral bus, and a keyboard controller. The microprocessor is a general-purpose digital processor that controls the operation of the computer. The microprocessor can be a single-chip processor or implemented with multiple components. Using instructions retrieved from memory, the microprocessor controls the reception and manipulations of input data and the output and display of data on output devices. The memory bus is utilized by the microprocessor to access the RAM and the ROM. RAM is used by microprocessor as a general storage area and as scratch-pad memory, and can also be used to store input data and processed data. ROM can be used to store instructions or program code followed by microprocessor as well as other data. A peripheral bus is used to access the input, output and storage devices used by the computer. In the described embodiments, these devices include a display screen, a printer device, a hard disk drive, and a network interface. A keyboard controller is used to receive input from the keyboard and send decoded symbols for each pressed key to microprocessor over bus. The keyboard is used by a user to input commands and other instructions to the computer system. Other types of user input devices can also be used in conjunction with the payment method linked to a mobile telephone number used on a cellular network or mobile network. The mobile telephone number may also be a satellite telephone number used with satellite phones. For example, pointing devices such as a computer mouse, a track ball, a stylus, or a tablet to manipulate a pointer on a screen of the computer system. The display screen is an output device that displays images of data provided by the microprocessor via the peripheral bus or provided by other components in the computer. The printer device when operating as a printer provides an image on a sheet of paper or a similar surface. The hard disk drive can be utilized to store various types of data. The microprocessor together with an operating system operate to execute computer code and produce and use data. The computer code and data may reside on RAM, ROM, or hard disk drive. The computer code and data can also reside on a removable program medium and loaded or installed onto computer system when needed. Removable program mediums include, for example, CD-ROM, PC-CARD, USB drives, floppy disk and magnetic tape. The network interface circuit is utilized to send and receive data over a network connected to other computer systems. An interface card or similar device and appropriate software implemented by microprocessor can be utilized to connect the computer system to an existing network and transfer data according to standard protocols.

Examples of suitable telecommunication networks 10 for the system for linking payment to a mobile number include but are not limited to global computer networks (e.g., the Internet), closed computer networks (e.g., intranets), financial networks, interbank networks (e.g., ATM (automatic teller machine) consortium or ATM network), wireless networks, telephone networks, cellular networks, satellite communications networks, cable communication networks (e.g., via a cable modem), microwave communications network, local area networks (LAN), wide area networks (WAN), campus area networks (CAN), metropolitan area networks (MAN), and home area networks (HAN). Various protocols may be utilized by the electronic devices for communications such as but not limited to HTTP (hyper-text transfer protocol), SMTP (simple mail transfer protocol), FTP (file transfer protocol) and WAP (wireless application protocol). The various wireless networks 10 that may be used include, but are not limited to, 3G, 4G, LTE, CDPD, CDMA, GSM, PDC, PHS, TDMA, FLEX, REFLEX, IDEN, TETRA, DECT, DATATAC, and MOBITEX. The system for linking payment to a mobile number may also be utilized with online services and internet service providers.

The Internet is an exemplary communications network 10. The Internet is basically comprised of a global computer network. A plurality of computer systems around the world are in communication with one another via this global computer network and are able to transmit various types of data between one another. The communications between the computer systems may be accomplished via various methods such as but not limited to wired, wireless, Ethernet, cable, direct connection, telephone lines, and satellite.

The service provider 30 may be any business that facilitates the electronic exchange, transfer of funds from one account to another account within a single financial institution or across multiple financial institutions. The service provider 30 may electronically transfer the funds via a computer-based system.

The service provider(s) 30 may transfer the money in various manners including credit card transactions, bank wire transfers, an automated clearing house (ACH) or interbank transfer. It is preferable that the service provider 30 electronically transfer funds utilizing either a credit card transaction for speed or an (ACH) transaction for lower cost and must be done within seconds of a payment request by a payer 80 without significant delay.

The service provider 30 is preferably an entity that transfers funds electronically between various financial institutions 152 and major credit card gateways. More than one service provider 30 may be utilized to ensure the ability to maintain constant uptime. In an embodiment, a service provider 30 may be a financial institution 152.

The SMS (short message service) network 14 (as shown in FIG. 1) handles SMS messages between mobile devices and short codes that are assigned to the service provider 30. The system may utilize the quick exchange of information between the payee 70, as provided via SMS or other messaging platforms, and the control center 20. This may enable a quick exchange of payment authorization information from the payer 80 who input it into the payer device 82 and transmit it to the SMS network 14 via an SMS message. In an embodiment, the transaction may occur within seconds of the payee device 72 requesting payment from the payer 80.

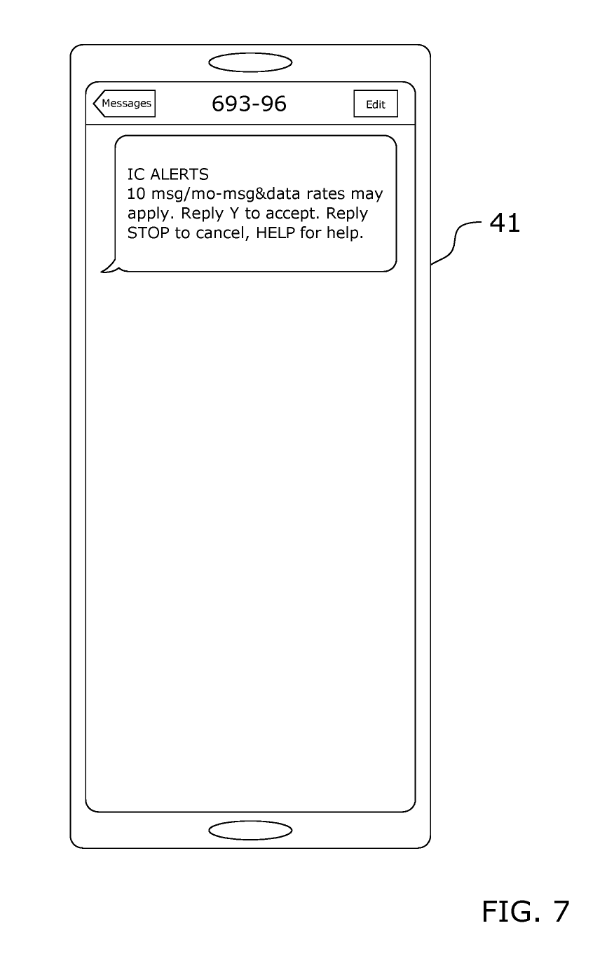

FIGS. 7, 8, 9, 10, 11, 12, and 13 illustrate exemplary messages 41, 42, 43, 44, 45, 46, and 47 exchanged between the payer 80 and the control center 20. The messages 41, 42, 43, 44, 45, 46, and 47 may be text-based messages from the payer 80 to the control center 20 via one or more telecommunication networks 10. The messages 41-47 may be comprised of various types of electronic communications that include but are not limited to instant messages (IM), text messaging, messages utilizing a mobile phone software application (app) and other types of electronic text-based communications between two parties, and may include a combination of different messaging platforms.

In an embodiment, SMS messages may be used to communicate between the control center 20 and the payer device 82, wherein the payer device 82 is preferably comprised of a mobile device. As such, payer device 82 and payee devices 72 need not be smart phones in order to communicate with control center 20, but may be any device capable of electronic messaging. Control center 20 may communicate with any SMS capable device (e.g. payer device 82 or payee device 72). Various SMS services may be utilized for the text messages or communication including, but not limited to MMS, TMS, or SMS.

The payer database 50 may be an electronic database hosted on a computer. The payer database 50 may be hosted on a local server at the service provider 30 or control center 20 or across a plurality of computers. The payer database 50 receives, stores, and transmits data relating to the payer 80 enrolled with the payee 70. The payer database 50 may include information related to the payer 80 such as, but not limited to a payer ID, name, address, e-mail address, mobile number, bank account information, credit card number, password, limits set by the payee 70, link 150 between the payee 70 and payer 80.

The mobile number is an identifier that uniquely identifies the payer 80 to each payee 70 within the payer database 50. In an embodiment, the mobile number of the payee device 72 may be used to identify the payer device 82 as well. The mobile number is utilized to send SMS messages to and from the payer 80 or payee 70 (via their respective devices).

A payer ID may be another identifier used to identify the payer 80 in the payer database 50. Similarly, the payee 70 may have a payee ID when the payee 70 enrolls. The name, address, or other financial information received from payee 70 and payer 80 may be used for creating credit card and ACH (automated clearing house) transactions. The email addresses or mobile phones may be used to provide receipts, a login name, and a retrieval mechanism. The bank account information may be used to create ACH transactions to pay for goods and services through the EFT (electronic funds transfer) Network 18. U.S. application Ser. No. 14/489,106, filed Sep. 17, 2014 and published as US-2015-0081553-A1 on Mar. 19, 2015 describes ACH payments and is incorporated herein by reference in its entirety. The credit card information may be used to create credit card transactions to pay for goods and services through the credit card network 16. The password may be used for providing access to the payer information by the payer 80 via online whereby the payer 80 can view and edit the payer information as stored within the payer database 50.

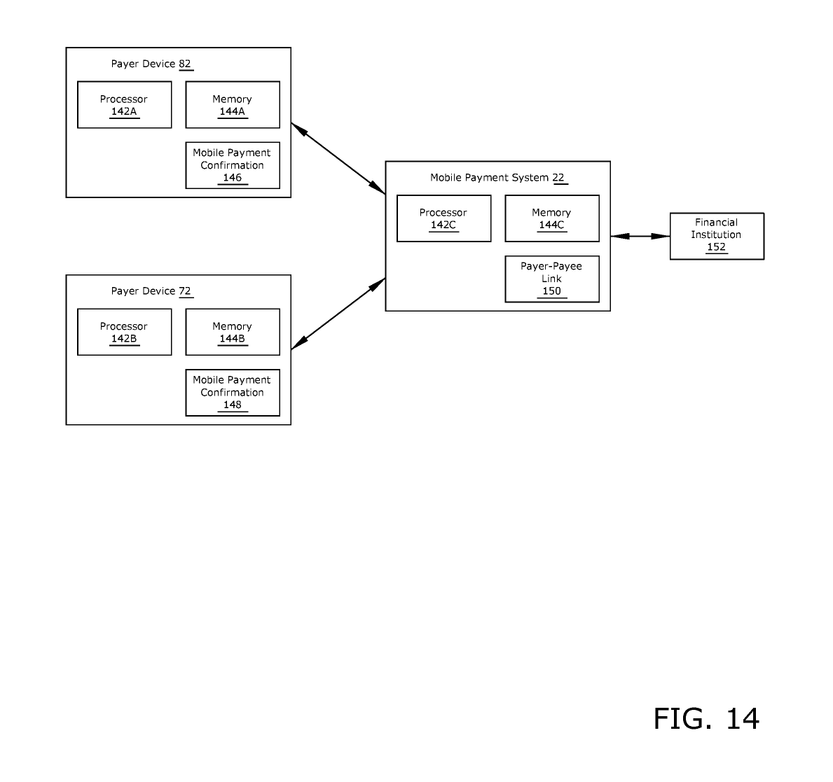

The limits or thresholds can be set for each payer 80 or each payee 70 to limit the amount authorized per transaction. The limit may help mitigate fraud. The link 150 (see FIG. 14) between payee 70 and payer 80 is stored in the payer database 50. The link 150 or association between payee 70 and payer 80 may allow payer 80 to pay payee 70 for goods and services.

In an embodiment, link 150 may include limit or threshold information. For example, link 150 may include limit or threshold information automatically authorizing payments to payee 70 (or a number of different payees 70) that are below a particular threshold. Or, for example, link 150 may include similar threshold information with regard to payees 70 with which payer 80 has conducted a minimum specified number of transactions.

There are two main financial institutions 152 (see FIG. 14) that may be involved with the system for linking payment to a mobile number. They are the payee financial institution 152 and the payer financial institution 152.

The payee financial institution 152 is comprised of a financial institution that the payee 70 has an account with where funds may be transferred into. This may occur from a credit via the EFT network 18 or a deposit of funds from the credit card network 16.

The payer financial institution 152 is comprised of a financial institution that the payer 80 has an account with where funds may be withdrawn for payment to the payee 70. This may occur from a debit via the EFT network 18 or a debit via the credit card network 16.

Once a request for payment has been submitted, payer financial institution 152 may directly transfer funds to payee financial institution 152. Or, for example, payer financial institution 152 may transfer funds to the mobile payment system 22 (e.g., control center device 22), which may then transfer funds to the payee financial institution 152. In an embodiment, mobile payment system 22 may deduct a fee for services prior to making the funds transferred. This fee may have been previously disclosed and agreed upon, and may be further disclosed in the receipt.

The payee 70 may be any business that provides goods or services for sale to a payer 80. The payee 70 must also have a bank account with a financial institution 152. The payee 70 sells goods or services in exchange for payment via a mobile number. The mobile number belongs to the payer 80 and is associated with a credit card that belongs to the payer 80 and/or a bank account that belongs to the payer 80.

The payee 70 may be any business that provides goods or services for sale to a payer 80. The payee 70 may also have a bank account with a financial institution 152. The payee 70 sells goods or services in exchange for payment via a mobile number. The mobile number belongs to the payer 80 and is associated with a credit card that belongs to the payer 80 and/or a bank account that belongs to the payer 80.

The payee device 72 is utilized or configured to transmit the mobile number of the payer 80 to the control center device 22 via the network 10. The payee device 72 receives authorization back in order to close the sale to the payer 80. The payee device 72 is comprised of an electronic device capable of receiving, transmitting and storing electronic data such as but not limited to a computer.

The payer 80 may be an individual or business that purchases goods or services from the payee 70. The system for linking payment to a mobile number is capable of being utilized with or configured to simultaneously handle a plurality of different payees 70 and a plurality of different payers 80.

In an embodiment, the payer's account may be comprised of a conventional transaction account (e.g., checking or savings account) or an account associated with a credit or debit card, or online account.

The payer 80 may purchase goods or services from the payee 70. On an initial or first transaction, the payer 80 may provide or be prompted to provide a mobile number and a credit card to create an account with which the payee 70 will use to collect payment. This information will be stored at the service provider 30 or control center 20 to be used for later purchases as well. In an embodiment, service provider 30 and control center 20 may be a single entity.

In an embodiment, the payer device 82 is utilized communicate with the SMS network 14 or another network 10. The payer device 82 may send and receive messages communicating the wish to pay the payee 70 for goods and/or services. The payee device 82 may be a mobile device that can send and receive SMS messages and is associated with a mobile number. Using the system described herein enables a payee 70, such as a merchant, to sell goods and/or services without having special customer-facing hardware, thus also enabling mobile sales.

In an embodiment, payment requests may originate from either payer device 82 or payee device 72. If, for example, the mobile payment system 22 receives requests from both devices 82, 72 within a specified period of time for an identical or similar price, the mobile payment system 22 may take additional steps to verify if one or two payments are to be made. For example, a payer 80 and payee 70 may both submit requests for payments for the same transaction to mobile payment system 22. Then, for example, mobile payment system 22 may automatically delete one of the requests, assuming that an accidental duplication has occurred (and may inform the parties) and process the other request. Or, for example, mobile payment system 22 may inform the parties of the multiple requests and request from one or both parties confirmation as to the payments.

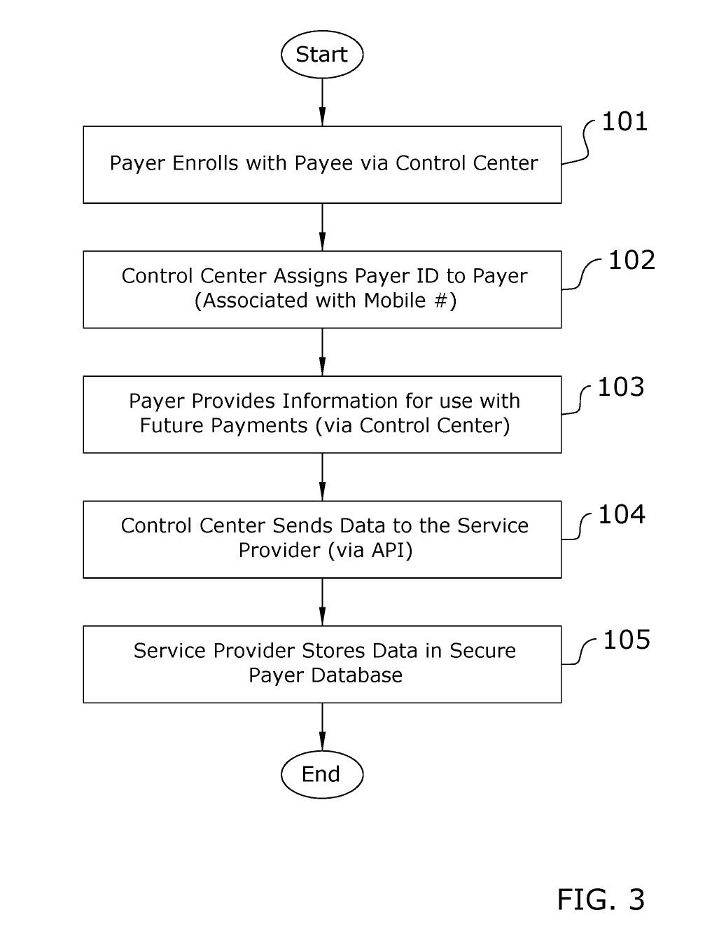

FIG. 3 is a flowchart illustrating a payer 80 enrollment with a payee 70, according to an example embodiment. As illustrated in FIG. 3, in step 101, the payer 80 and the payee 70 enroll via control center 20. The enrollment may take place via a website or web interface 12, an app, over text messaging, via an API through the payee device 72 that communicates with the control center 20. In an embodiment, the web interface 12 may include a mobile application. The payee device 82 used by the payee 80 for enrollment may be comprised of a computer (e.g., a laptop, mobile device, smart phone, etc.). The website hosted by the control center 20 would be comprised of a computer linked to the Internet 12 or other network. In an embodiment, a payer 80 may electronically invite a payee 70 to enroll via control center 20 or the web interface 12, or vice versa.

In step 102, the control center 20 may assign a payer ID to the payer 80 or payer device 82. In an embodiment, payer device 82 may be specially configured to interact with system (e.g., mobile payment configuration 146, which may include the payer ID that may be later used for transactions). In an embodiment, payer ID may be the mobile phone number.

In step 103, various types of enrollment data is requested from the payee 70 and/or the payer 80 such as mobile number, name, address, email address, bank account information, password, when they are enrolling in the system. This information may enable account information to be verified such that financial transactions may be authorized between the parties. In steps 104 and 105, the payer 80 information may be sent and stored in the payer database 50 at the service provider 30. The payer information can be used for the immediate transaction or used in the future via the mobile number or payer/payee ID.

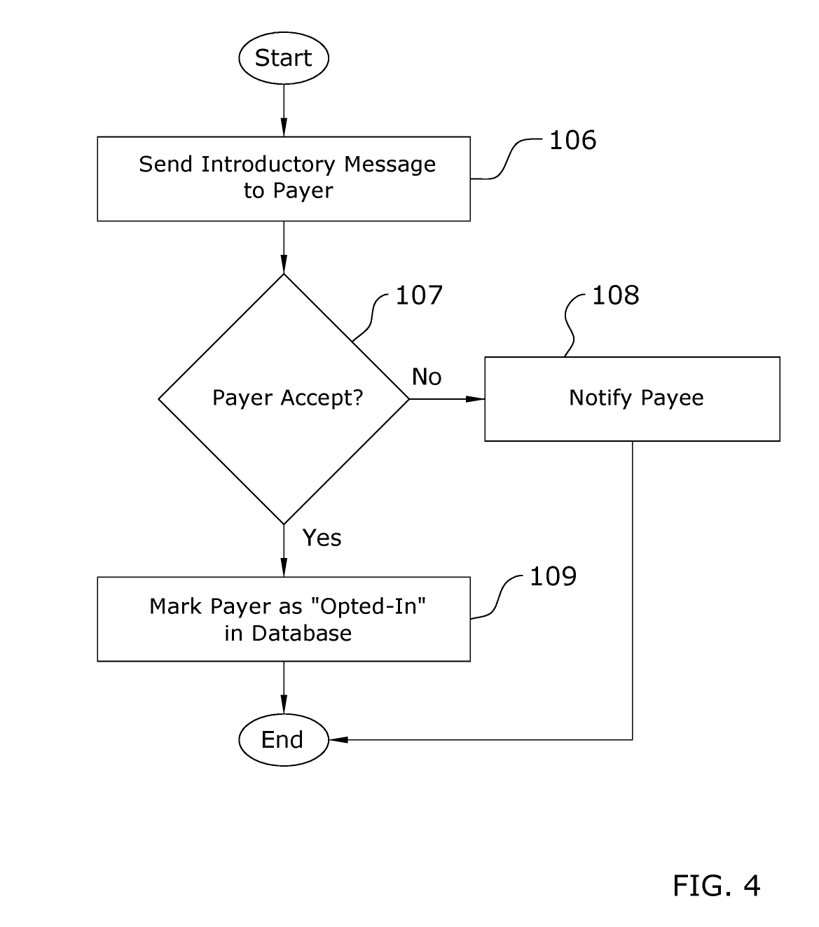

FIG. 4 is a flowchart illustrating a payer confirmation, according to an example embodiment. As shown in FIG. 4, after enrollment, an introductory message 41 is sent to the payer 80 asking the payer 80 to opt-in to the service as shown step 106. An exemplary introductory message 41 is shown in FIG. 7. FIG. 7 is an exemplary illustration of an introductory message, according to an example embodiment.

In step 107 it is determined whether or not the payer 80 accepts enrollment. If the payer 80 does not accept enrollment, then in step 108 the payee 70 is notified (e.g., via a SMS message to payee device 72) that the transaction has failed or that payer 80 has declined payment. In an embodiment, the enrollment request may be received directly from payee 70. Or, for example, payee 80 may send payee 70 an enrollment request.

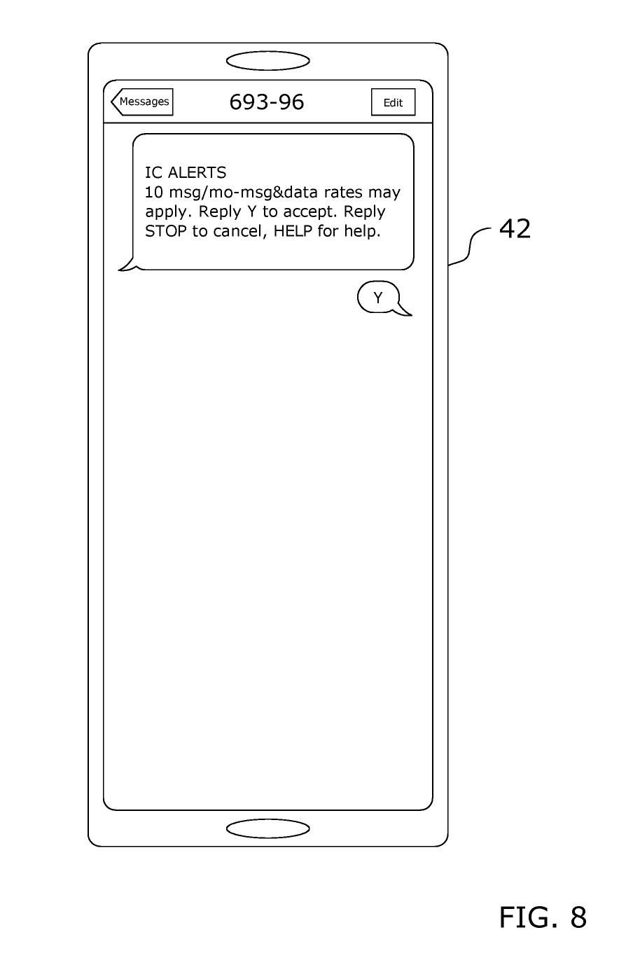

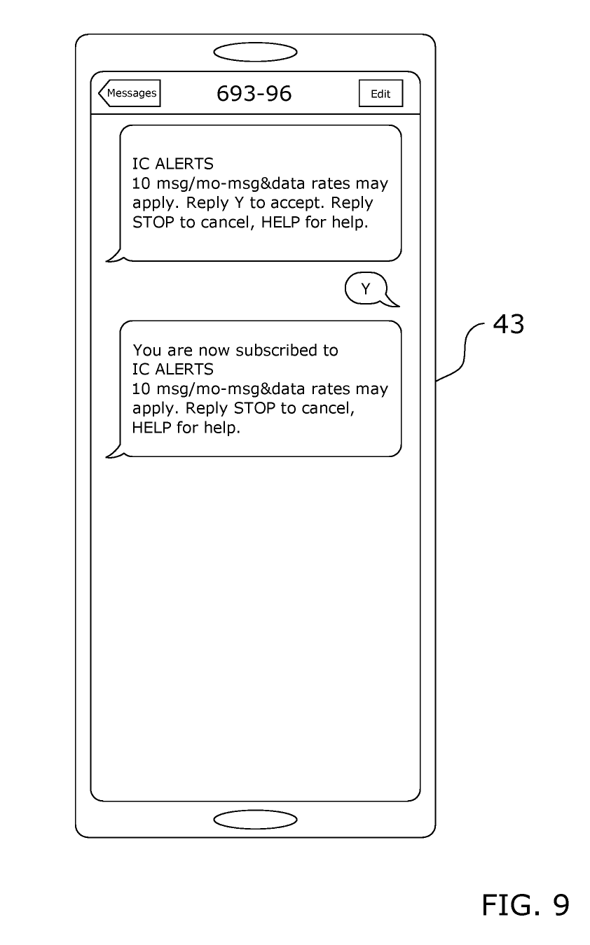

If however, payer 80 accepts enrollment, then in step 109 the payer 80 is marked as “opted in” in payer database 50. Message 42 of FIG. 8 shows the payer 80 using the payer device 82 sending an acceptance message 42 through the SMS network 14 to the control center 20. FIG. 8 is an exemplary illustration of an acceptance message, according to an example embodiment. Immediately, the control center 20 sends a confirmation message 43 back to the payer 80 as shown in message 43 of FIG. 9. FIG. 9 is an exemplary illustration of a confirmation message, according to an example embodiment. This completes the set-up of all SMS communications. An acceptance message by the payer may be comprised of various forms such as, but not limited to, “Y”, “Yes”, “Confirmed”, a PIN number, biometric information (e.g. fingerprint) and the like.

The payer 80 can choose to cancel the service by replying “STOP” to the short code that is used to communicate with the SMS network 14. The payer 80 can also choose to get help by replying “HELP” to the short code. This will send a message that includes a customer service phone number to the service provider 30.

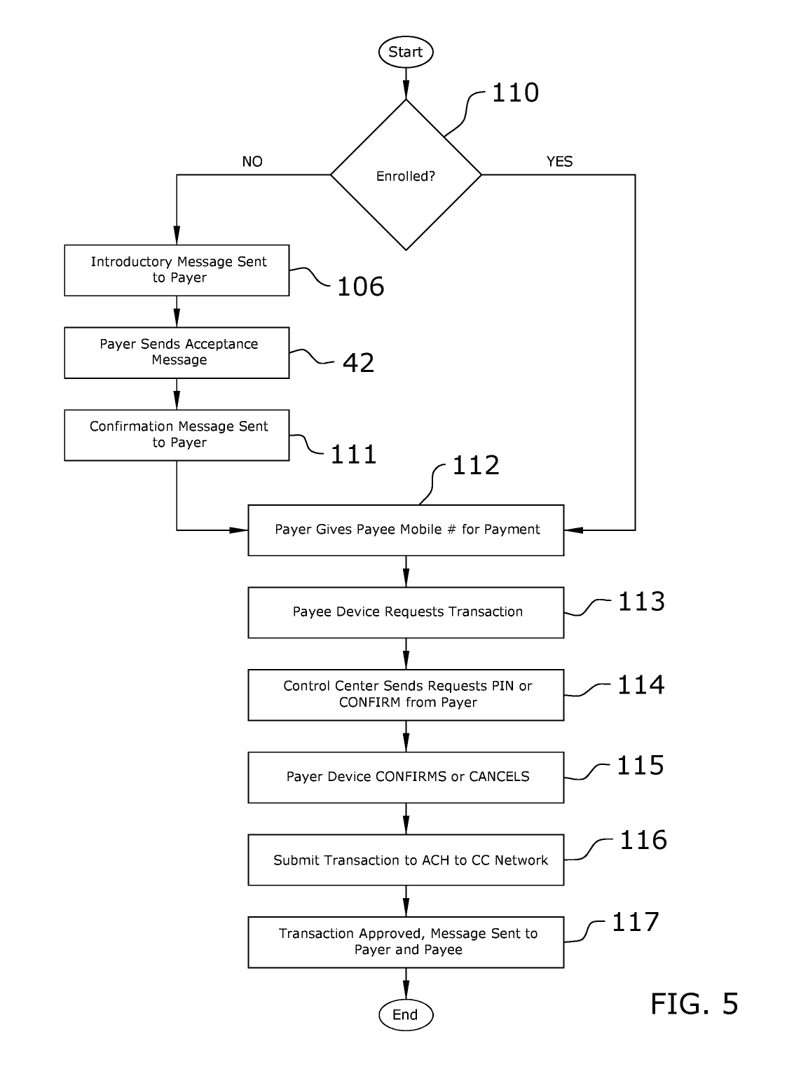

FIG. 5 is a flowchart illustrating overall messaging of a system for linking payments to a mobile number, according to an example embodiment. At step 110, it is determined whether or not the payer 80 and payee 70 are enrolled in the system. If not, then step 106, message 42, and step 111 are performed. In step 111, the system sends a message to the payee 70 that the payer 80 has accepted enrollment or otherwise been enrolled. The enrollment verification or process may occur equally with regard to payer 80 and payee 70, and may fail if either party declines enrollment. If both payer 80 and payee 70 have already been enrolled (and a link 150 already exists), or payer 80 has otherwise accepted enrollment, then processing continues to step 112B.

Enrollment or registration by a payer may be completed via a website, mobile phone app or by calling a telephone number where the payer's mobile telephone number and relevant payment information is entered. The payer may also enter multiple payment options (e.g. credit cards, checking accounts, etc.) that may be used for various types of transactions. For example, the payer may select a first credit card for all transactions at Store 1, a second credit card for all transactions at Store 2 and a first checking account is used for all transactions at Store 3. If a transaction is completed at a store not recognized by the control center, a default or primary payment option is used.

Alternatively, enrollment or registration by the payer may occur directly at a physical store where the payer gives the cashier (or other store employee) their mobile telephone number and their credit card payment information. The credit card payment information is preferably provided to the store by the user swiping the credit card which pulls the credit card number data along with personal data (e.g. name) of the payer from the credit card and then transmits the data to the control center where an account is created in a database for the payer. The account at the control center preferably includes at least the name, mobile telephone number for text messaging and financial account information used for making payments on transactions the payer confirms. After the payer enrolls, the payer no longer has to swipe their credit card or provide other financial information to the retail store thereafter thereby protecting the retail store and the payer from credit card fraud because the payer only has to provide the payer identifier (e.g. mobile telephone number of the payer) to the store when they make a subsequent purchase at the store. The term store is used as any business or individual where financial funds are to be transferred from the payer to the store (i.e. payee). Additional data may be stored in the database at the control center relating to the payer and the payer device 82 such as, but not limited to, data of registration, typical usage, last date usage of payment system and the unique mobile device identifier for the payer device 82. The store may also require the payer to sign an agreement authorizing the store to use the payer identifier (e.g. mobile telephone number) in the future to make payments to the payee 70.

At step 112B, the payer 80 gives the payee 70 a mobile telephone number or other payer identifier (e.g., payer identifier, biometrics, full name, email address) associated with the payer and the payer device 82 in exchange for goods and/or services. The control center database identifies the payer using the payer identifier provided and identifies the mobile telephone number associated with the payer and the payer device 82. At step 113, the payee 70 requests confirmation of payment which via a text message vis SMS or other service. The payee 70 enters the mobile number or other payer identifier into the payee device 72 that communicates with the control center 20 over the internet 12. The request for payment may be made by sending a text message via SMS (or other form of message) including the amount of payment and the payer mobile number (or payer ID). Similarly this process may originate from the payer device 82 providing the payee ID or mobile number.

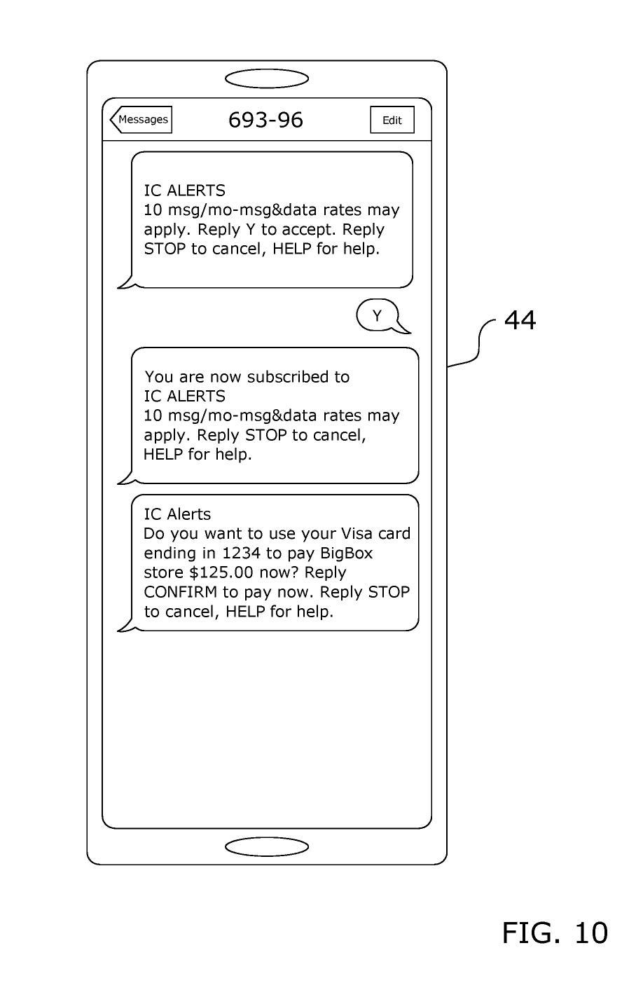

At step 114, the payee device communicates a request to the control center 20 which includes the payer identifier and may also include the store identifier, the dollar amount of the purchase. The communication by the payee device may be completed via the Internet or other communications network. At step 115A, the control center 20 (or the merchant) sends a payment request message to the payer 80 to the payer device 82 via the SMS network 14. An exemplary message is shown in message 44 of FIG. 10. The message is preferably comprised of a text message but may be comprised of other types of messages. FIG. 10 is an exemplary illustration of a payment request message, according to an example embodiment. Through the payer device 82, the payer views the request from the control center and then selects an option relating to the request. The selection by the payer on the payer device 82 may be physically touching a button on the screen or keyboard. Alternatively, the selection by the payer on the payer device 82 may be performed by entering a text message reply (e.g. “Y”, “Yes”, “Confirm”, “N”, “No”, “Deny”, biometric information, a PIN number, etc.) to the text message from the control center to approve or disapprove the financial transaction. The data sent by payer device 82 to the control center 20 (or merchant directly) preferably includes identification of the mobile telephone number and a physical identifier for the payer device 82 to provide proof to the control center that the authorized payer device 82 is communicating the message. The physical identifier for the payer device 82 may be comprised of any unique identifier used to identify a specific mobile device such as, but not limited to, a device identifier or a mobile device identifier. The identifier for the mobile device may be access by the app and/or the text messaging application to send the identifier for the mobile device to the control center. The control center can use the mobile device identifier to determine if the device being used as the alleged payer device 82 is in fact the correct and authorized mobile device. Only the mobile device and the corresponding unique mobile device identifier that originally registered the account for the payer will be allowed to authorize a financial transaction regardless of the mobile telephone number alleged to be sending the message from (protects against fraud such as spoofing). During registration with the mobile device (or when the mobile device is first used to authorize a transaction), the control center 20 records the unique mobile device identifier of the payer device 82 and verifies that future messages from the alleged payer device 82 are from a mobile device that has the same unique mobile device identifier (if not, the transaction is declined). Hence, there is preferably a dual confirmation system wherein the payer confirms that they would like the transaction approved by sending a reply text message to the control center and the control center verifies both the text message content and the unique mobile device identifier (if either one is invalid, then the transaction is not confirmed; only if the payer confirms the transaction and the unique mobile device identifier is verified to be correct will the financial transaction be completed). While a smartphone is preferred, a smartphone is not required with a dumb mobile phone suitable for usage that is not capable of running applications and is only capable of basic text messages. It can be appreciated that a custom app is optional and that conventional text message applications on the mobile device are suitable for usage in various embodiments of the present invention.

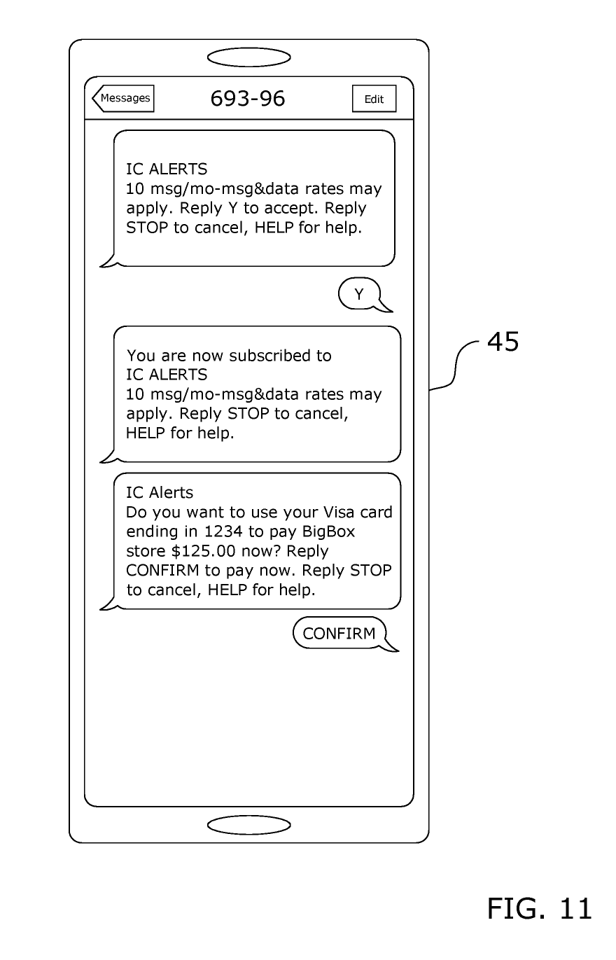

At step 115B, the control center 20 may receive either a CONFIRM or CANCEL message from payer device 82 (or payee device 72). Message 45 of FIG. 11 represents the payer 80 replying to the short code via a payer device 82. FIG. 11 is an exemplary illustration of a CONFIRM message, according to an example embodiment. There are three options to approve the payment method. The payer 80 can reply “CONFIRM” to approve the transaction as displayed in FIG. 11. In an embodiment, a party confirming payment may include a note that may be visible to the other party, or may include a personal memo that is not visible to the other party. In an embodiment, a partial payment (of less than the full amount) may be confirmed. Or, for example, with a rejection by payee 70, an additional, alternative payment may be requested from the payer 80.

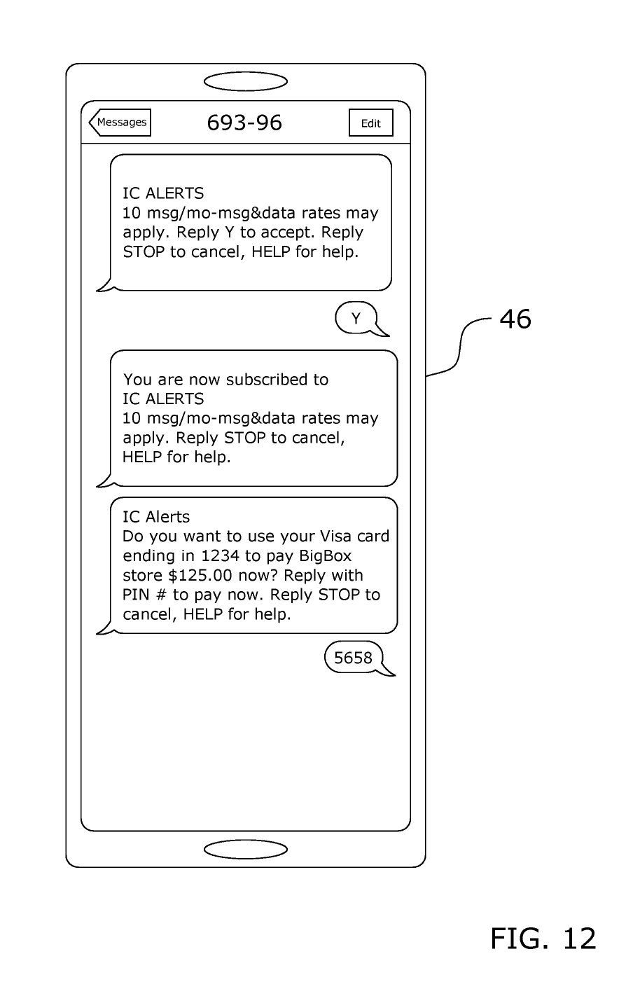

For high dollar amounts (e.g., beyond a particular limit or threshold that may be set or agreed upon by the payer 80 and/or control center 20) the payer 80 may be required to enter a Personal Identification Number (PIN). An exemplary PIN reply is shown in message 46 of FIG. 12. FIG. 12 is an exemplary illustration of a confirmation to pay via a PIN, according to an example embodiment.

In an embodiment, the payer 80 can reply “NEXT” for a request for the system to display additional payment options that may be available or are already setup. If the payer 80 enters “NEXT”, the SMS network 14 delivers the message to the control center 20. The control center 20 may reply with additional payment options that are available to pay the current payee 70. The payer 80 could then reply to the short code with which payment option to use for the transaction. At that time, the SMS network 14 would deliver the message to the control center 20 with the payment option. The control center 20 would then respond with a confirmation message as to the selected payment option.

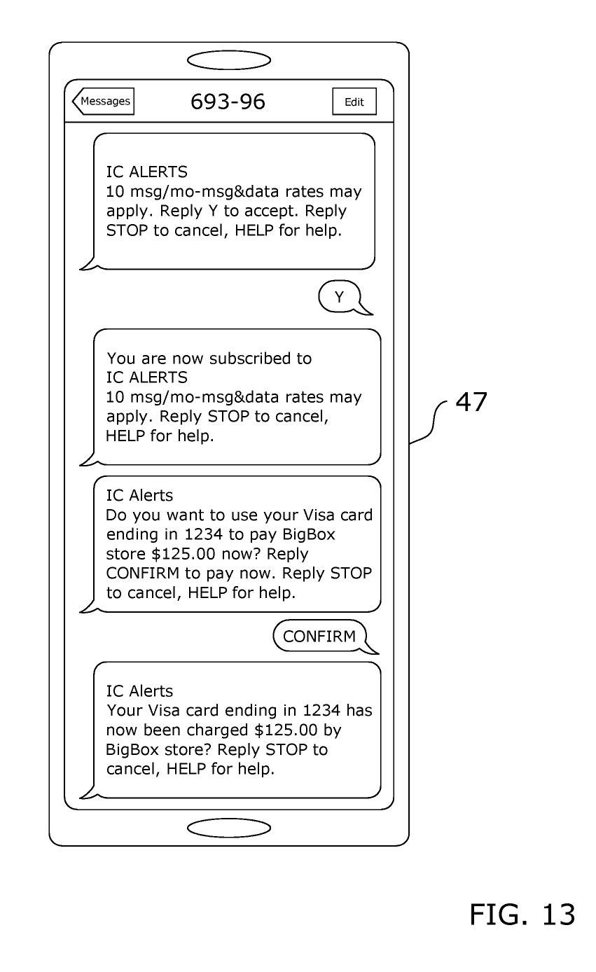

If the payment is approved, at step 116 a transaction may be submitted to a financial institution 152, which may include a ACH or credit card network. The financial institution 152 may process the payment and return a result to control center 20. Control center 20 may then notify the payer 80 and/or payee 70 as to the final resolution. Message 47 displayed in FIG. 13 shows an exemplary confirmation message to the payer 80. FIG. 13 is an exemplary illustration of a receipt of payment, according to an example embodiment. Message 47 may be a receipt of payment confirming the sales or other financial transaction.

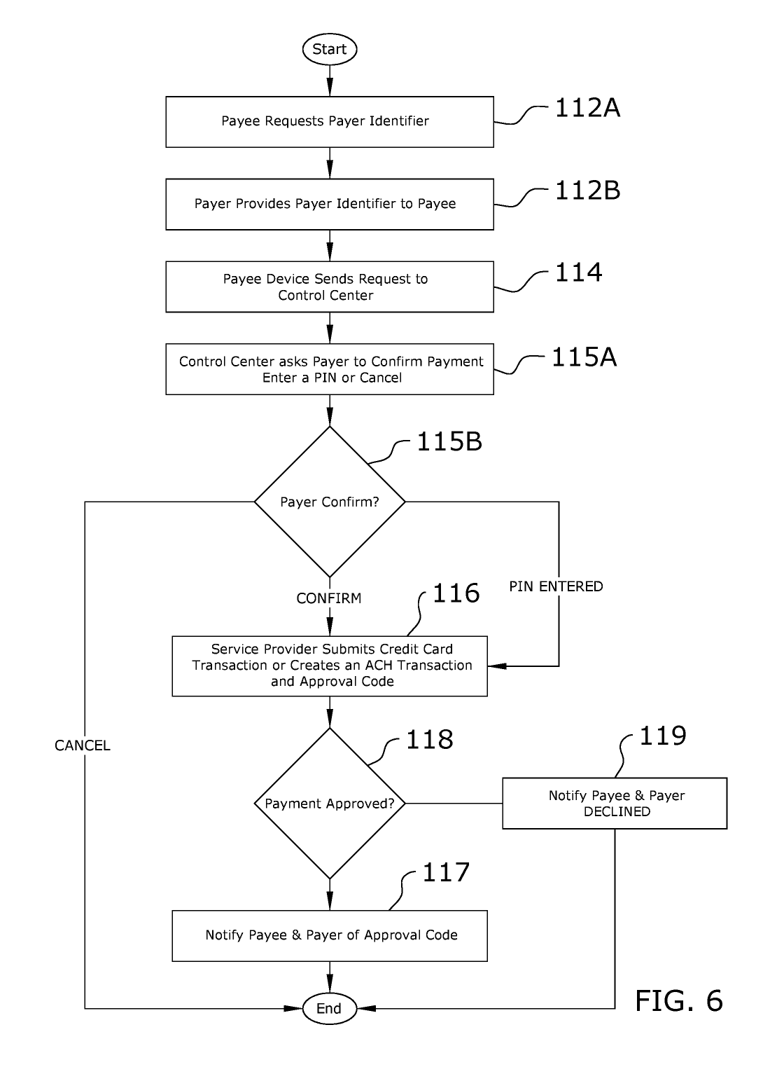

FIG. 6 is a flowchart illustrating a request for payment by a payee, according to an example embodiment. FIG. 6 illustrates the overall operation of a request for payment. At step 112A, the payee requests a payer identifier. The payer identifier may be any identifier that identifies the payer such as, but not limited to, a mobile telephone number, the payer's name, biometric information from the payer (e.g. fingerprint, eye-scan) or other identifier (e.g. a series of characters forming an identifier such as “4299123AB223”). It is preferable that the payer identifier used is comprised of the mobile telephone number of the payer device 82. The payer identifier is used to identify the payer and the associated mobile telephone number. The request by the payee in step 112A may be done at a physical store (e.g. by the cashier), on a website interface at checkout or via telephone. Examples of where the payer would be requested the payer identifier include, but are not limited to, retail stores where the payer verbally tells the cashier their payer identifier, website shopping carts where the user enters their payer identifier, a call center called by the payer after viewing an infomercial where the payer gives the payer identifier verbally to a receptionist at the call center and the like. The medium of requesting the payer identifier is not limited to these applications and may be comprised of any communication medium where transmittal of the payer identifier is allowable.

At step 118, the control center 20 may determine if the payment submitted to the financial institution 152 was approved. This process can either be a payment via the EFT (electronic funds transfer) network 18 or the credit card network 16 depending on what payments the payee 70 will accept and what payment options the payer 80 has setup at the control center 20.

If the payment is to use a credit card via the credit card (cc) network 16, the payee service provider 30 knows within seconds of submitting the transaction if it is approved or declined. Once the service provider 30 receives the authorization code back from the credit card network 16, it sends it back to the payee device 72 in order for the payee 70 to post the payment and apply it to the sale of goods and services.

Some payee's 70 will also accept ACH payments. One major difference between ACH payments and credit card payments is the speed in which they are approved and settled at the financial institutions 60. The service provider 30 knows within seconds of a credit card transaction being approved. However, it takes days to know for certain if an ACH transaction is approved. With a credit card transaction, the service provider 30 can tell the payee 70 very quickly if the transaction is approved. So, with an ACH transaction, the service provider 30 can provide a code that they have received the payment request and will submit it to the EFT Network 18.

If the payment was not approved, then at step 119, the payer 80 and payee 70 may be informed that the transaction was not successful.

FIG. 14 illustrates an example embodiment of a system for linking a payment to a mobile number. A mobile payment system 22 (interchangeably referred to herein as control center 20, control center device 22, and/or service provider 30) may manage a payment or other financial transaction between a payer device 82, a payee device 72, and one or more financial institutions 152.

Payer device 82, payee device 72, and mobile payment system 22 may each have one or more processors 142A-C. Processors 142 may be computing, including mobile, processors configured for telecommunications and processing transactions in the manner described herein.

Payer device 82, payee device 72, and mobile payment system 22 may each have a memory 144A-C. Memories 144 may include RAM, ROM, hard disk storage, and/or cloud storage access to information.

In addition to have processors 142, and memory 144, payer device 82, payee device 72, and mobile payment system 22 may each be specially configured to operate within the system for linking a payment to a mobile number. Payer device 82 may include a mobile payment configuration 146. Mobile payment configuration 146 may include settings, options, or configurations necessary to be operable with mobile payment system 22. For example, mobile payment configuration 146 may include receiving and storing a phone number necessary by which to communicate with mobile payment system 22. The phone number may be particular to payer 80 communications with mobile payment system 22. Such communications may include enrollment, configuring a threshold or limit for payments, providing financial information, setting up a personal identification number, authorizing or denying requested transactions, and receiving communications as to the results of transactions.

Payee device 72 may include a mobile payment configuration 146. Mobile payment configuration 148 may include settings, options, or configurations necessary to be operable with mobile payment system 22. For example, mobile payment configuration 148 may include receiving and storing a phone number necessary by which to communicate with mobile payment system 22. The phone number may be particular to payee 70 communications with mobile payment system 22. Such communications may include enrollment, requesting payment for transactions, providing financial information, and receiving communications as to the results of transactions.

Mobile payment system 22 may include a payer-payee link 150. Payer-payee link 150 may include settings, options, or configurations necessary to receive and transact payment requests between payer device 82 and payee device 72. For example, payer-payee link 150 may include an association between a mobile phone number (or other identifier) corresponding to both payee device 72 and payer device 82 enabling financial transactions between the parties, and may also include a history of messages transmitted between the parties and mobile payment system 22.

Mobile payment system 22 may also be in communication with one or more financial institutions 152. Financial institution 152 may be any financial institution or payment processing system associated with payer 80, payee 70, or both. Financial institution 152 may, for example, include an ACH, credit card system, bank or other institution. Upon receiving a request and corresponding authorization from payee 70 and payer 80, mobile payment system 22 may request that funds be transferred between the parties through communications with one or more financial institutions 152. Mobile payment system 22 may then communicate, in real-time, the result (success, failure) of the transfer.

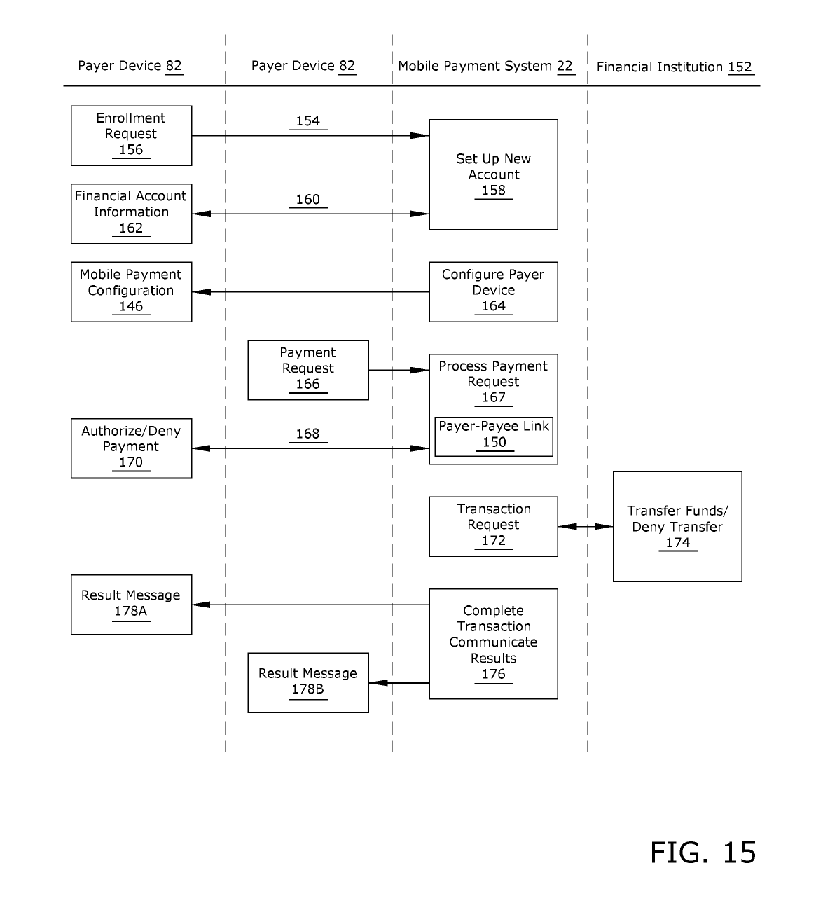

FIG. 15 is an example swim-lane diagram illustrating example operations of a system for linking payments to a mobile number, according to an example embodiment. At 154, an enrollment request 156 may be transmit to mobile payment system 22. The enrolment request 156 may be submitted via SMS or another messaging system, over the web, or through using another communications system. For example, a user may text the phrase “ENROLL” to a phone number associated with enrolling with mobile payment system 22.

At 158, mobile payment system 22 may set up a new account based on the enrollment request 156. For example, mobile payment system 22 may be able to verify that the phone number associated with the ENROLL text does not already have an account set up with the system. If an account has previously been established then mobile payment system 22 may provide payer 80 (e.g., user of payer device 82) with options to retrieve a password or other account information.

If no account has been previously established with a phone number corresponding to payer device 82, mobile payment system 22 may set up a new account. At step 160, there may be back and forth communication between mobile payment system 22 and payer device 82 in which financial and account information 162 is provided to mobile payment system 22 to set up the new account 158. This information 162 may include name, address, bank name, bank account numbers, authorizations for funds transfers, credit card numbers, security questions, personal identification number (PIN) activation, or any other information necessary to authorize or enable mobile payment system 22 to accept and/or send funds on behalf of payer 80.

In an embodiment, once an account has been set up 158, mobile payment system 22 may configure payer device 164 with mobile payment configuration 146. Mobile payment configuration 146 may include a specialized setting on payer device 82 that may be necessary to request payments from mobile payment system 22. In an embodiment, mobile payment configuration 146 may include automatically adding a special signature or code to SMS or other messages (particularly payment request messages) that are transmitted to the mobile payment system 22 from the payer device 82.

A similar set up and configuration process may be performed on behalf of payee 70 and payee devices 72 as well. A particular user/user device may be set up as a payer device 82, payee device 72, or as both (operating as payee device 72 in some transactions and as a payer device 82 in other transactions). In an embodiment, a device set up to act as payer device 82 and payee device 72 may include mobile payment configuration 146 for when operating as payer device 82, and mobile payment configuration 148 for when operating as payee device 72.

When a transaction occurs between payer 80 and payee 70, payee 70 may submit a payment request 166 to mobile payment system 22. Payment request 166 may include various information about a payment that is requested from payer 80. Payment request 166 may include an amount requested, a date/time of request, a note or comments about the request, and a payment ID or mobile phone number associated with payer 80 or payer device 82.

At 167, mobile payment system 22 may process the payment request 166. Mobile payment system 22 may receive a special code or authorization with payment request 166 (that was transmit as part of mobile payment configuration 148). When the code has been confirmed, the processing 167 may also include communications 168 with payer device requesting authorization or denial of the payment request 170.

Mobile payment system 22 may transmit the payment request information 166 to payer device 82, including a store/retailer/requester name associated with an account of payee 70. In an embodiment, if this is a first transaction between payer 80 and payee 70, the communications 168 may include this information. Payer device 82 may then confirm payment, authorize payment, authorize partial payment, or deny payment of payment request 166. In an embodiment, payer device 82 may indicate from which financial account(s) payment is to be made. This authorization may be received and a payer-payee link 150 may be established. In an embodiment, a first transaction may always require a PIN confirmation from payer 80.

Payer-payee link 150 may indicate a transaction history between payer 80 and payee 70. In an embodiment, if payer 80 and payee 70 are doing regular business, payer 80 may authorize automatic recurring payments to payee 70, or a threshold that does not require explicit authorization 170. For example, link 150 may include instructions for mobile payment system 22 to automatically authorize any payment requests 166 below $50.

If authorization was denied, mobile payment system 22 may transmit a message to payee device 72 indicating that the authorization was denied. Otherwise, mobile payment system 22 may transmit a transaction request 172 to one or more financial institutions 152 of payer 80 requesting a transfer of funds. The financial institution(s) 152 may ensure that payer 80 has enough funds, and with the payee 70 financial institution information received as part of transaction request 172, may transfer the funds. If payer 80 does not have enough funds, then this result may be communicated to mobile payments system 22. If the funds transfer was successful, this information may be transmitted back to mobile payment system 22.

At 176, with the confirmation/denial of funds transfer, mobile payment system 22 may communicate a result message 178 to payer device 82 and payee device 72. The result messages 178A and 178B may indicate the success/failure of the transaction.

In an embodiment, a central communication unit (e.g., control center 20, control center device 22, mobile payment system 22, or service provider 30) may be comprised of any central communication site where communications are preferably established with. The central communication units may be comprised of a server computer, cloud based computer, virtual computer, home computer or other computer system capable of receiving and transmitting data via IP networks and the telecommunication networks. As can be appreciated, a modem or other communication device may be required between each of the central communication units and the corresponding telecommunication networks. The central communication unit may be comprised of any electronic system capable of receiving and transmitting information (e.g. voice data, computer data, etc.).

In an embodiment, a mobile device (e.g., payer device 82, payee device 72) may be comprised of any type of computer for practicing the various aspects of the system for linking payment to a mobile telephone number. For example, the mobile device can be a personal computer (e.g. APPLE® based computer, an IBM based computer, or compatible thereof) or tablet computer (e.g. IPAD®). The mobile device may also be comprised of various other electronic devices capable of sending and receiving electronic data including but not limited to cellular phones, basic mobile phones, smartphones, mobile phones, telephones, satellite phones, handheld mobile phones, personal digital assistants (PDAs), mobile electronic devices, portable electronic devices capable of messaging communications (e.g. SMS text messaging), handheld wireless devices, two-way radios, smart phones, communicators, video viewing units, television units, television receivers, cable television receivers, pagers, communication devices, and digital satellite receiver units.

In one embodiment, the mobile device is comprised of a portable electronic device that is connected to the text messaging account of a mobile phone so that when text messages are sent to the mobile phone the text messages also go to the portable electronic device for display. In one embodiment of the present invention where multiple devices are associated with a mobile telephone number, the payer (or the payee) can select an option allowing only one or more (or none) selected devices to be able to send messages approving of financial transactions (e.g. only a mobile phone associated with the telephone number; both a mobile phone and a portable electronic device such as an IPAD® both having messaging connected to a single mobile phone number).

When multiple devices are allowed to transmit a message, the system preferably will use the first message received from a first device if two messages are transmitted (e.g. if a mobile phone transmits a “Yes” message first and a portable electronic device transmits a “No” message after the mobile phone's message, the “Yes” message by the mobile phone will be accepted instead of the “No” message by the portable electronic device). However, the system may be setup by the payer (or payee) so that one of the devices can override another device or the second message takes priority over the first message.

In one embodiment of the present invention, the payer registers an account with the control center (or a merchant directly) providing at least their mobile telephone number and a credit card to charge for financial transactions. When the payer desires to make a purchase of goods or services, the payee requests a payer identifier (e.g. mobile telephone number, name, email address, unique payer identifier, etc.) and the payer provides the payer identifier (e.g. mobile telephone number) to the payee. The payee transmits the payer identifier (along with other details of the financial transaction such as merchant/store ID and the amount of the transaction) to the control center for verification to authorize or reject the financial transaction. The control center verifies that a payer exists in the database corresponding to the payer identifier provided along with any other conditions. If the control center determines that the payer exists, the payer then transmits a text message to the payer device (e.g. mobile phone) using the mobile telephone number associated with the payer in the database requesting confirmation by the payer to pay the amount of money to the merchant (or other business or individual). The payer then either accepts or rejects the authorization request by selecting an option or sending a reply text message back to the control center via the payer device which is sent to the corresponding telephone number for the control center. The reply text message from the payer device is received by the control center along with other data associated with the message such as, but not limited to, the unique mobile device identifier and location data (e.g. GPS data from the payer device). While not required, the control center preferably determines if the mobile device identifier corresponds to the original (or the last) mobile device identifier used by the payer for enrollment and/or the last transaction. If the mobile device identifier is different, the transaction can either be denied or the control center can request additional information from the payer basically escalating the security in real-time such as by requesting a PIN number, biometric information (e.g. fingerprint), the payer's date of birth, the last 4 digits of the payer's social security number or the last 4 digits on the credit card of record via text message to the payer device which the payer responds to via the payer device. It can be appreciated that a PIN or the other increased security response (e.g. last 4 digits of credit card or social security number) may be used by default for all confirmations by the payer instead of a simple “Yes” or “Confirm” text message. If the escalated security inquiry by the control center is verified and satisfied, the control center then may process the reply text message by the user to either authorize the financial transaction request by the payee using the payer identifier or rejecting the same. The payee is notified of the results of the same via a confirmation message.

In one embodiment of the invention, if the payer has not used their account for a period of time (e.g. 2 months), the control center may send a text message to the payer device to verify that the payer still wants to keep the account active. For example, the control center could send a text message to the payer device at the mobile telephone number of record such as “AUTOMATIC MESSAGE FROM INTERCEPT PAY: Do you want to keep your account active? Reply with ‘Y’ or ‘N’”. The payer then replies via the payer device with “Y” to keep the account active with the mobile telephone number. If no reply text message is received after a period of time (e.g. 1 day), the control center can deactivate the account to prevent future financial transactions until or unless the payer provides an escalated security response such as the last 4 digits of their credit card. Alternatively, if a payer has not used their account for a period of time (e.g. 1 month), the control center may require an escalated security response instead of a standard confirmation message to prevent the mobile telephone number from being misused or accidentally used by a third-party.

What has been described and illustrated herein is are different possible embodiments of the invention along with some of their variations. The terms, descriptions and figures used herein are set forth by way of illustration only and are not meant as limitations. Those skilled in the art will recognize that many variations are possible within the spirit and scope of the invention in which all terms are meant in their broadest, reasonable sense unless otherwise indicated. Any headings utilized within the description are for convenience only and have no legal or limiting effect.

Any and all headings are for convenience only and have no limiting effect. Unless otherwise defined, all technical and scientific terms used herein have the same meaning as commonly understood by one of ordinary skill in the art to which this invention belongs. Although specific terms are employed herein, they are used in a generic and descriptive sense only and not for purposes of limitation. All publications, patent applications, patents, and other references mentioned herein are incorporated by reference in their entirety to the extent allowed by applicable law and regulations.

The data structures and code described in this detailed description are typically stored on a computer readable storage medium, which may be any device or medium that can store code and/or data for use by a computer system. This includes, but is not limited to, magnetic and optical storage devices such as disk drives, magnetic tape, CDs (compact discs), DVDs (digital video discs), and computer instruction signals embodied in a transmission medium (with or without a carrier wave upon which the signals are modulated). For example, the transmission medium may include a telecommunications network, such as the Internet.

At least one embodiment of the system for linking payment to a mobile number is described above with reference to block and flow diagrams of systems, methods, apparatuses, and/or computer program products according to example embodiments of the invention. It will be understood that one or more blocks of the block diagrams and flow diagrams, and combinations of blocks in the block diagrams and flow diagrams, respectively, can be implemented by computer-executable program instructions. Likewise, some blocks of the block diagrams and flow diagrams may not necessarily need to be performed in the order presented, or may not necessarily need to be performed at all, according to some embodiments of the invention. These computer-executable program instructions may be loaded onto a general-purpose computer, a special-purpose computer, a processor, or other programmable data processing apparatus to produce a particular machine, such that the instructions that execute on the computer, processor, or other programmable data processing apparatus create means for implementing one or more functions specified in the flow diagram block or blocks. These computer program instructions may also be stored in a computer-readable memory that can direct a computer or other programmable data processing apparatus to function in a particular manner, such that the instructions stored in the computer-readable memory produce an article of manufacture including instruction means that implement one or more functions specified in the flow diagram block or blocks. As an example, embodiments of the invention may provide for a computer program product, comprising a computer usable medium having a computer-readable program code or program instructions embodied therein, said computer-readable program code adapted to be executed to implement one or more functions specified in the flow diagram block or blocks. The computer program instructions may also be loaded onto a computer or other programmable data processing apparatus to cause a series of operational elements or steps to be performed on the computer or other programmable apparatus to produce a computer-implemented process such that the instructions that execute on the computer or other programmable apparatus provide elements or steps for implementing the functions specified in the flow diagram block or blocks. Accordingly, blocks of the block diagrams and flow diagrams support combinations of means for performing the specified functions, combinations of elements or steps for performing the specified functions, and program instruction means for performing the specified functions. It will also be understood that each block of the block diagrams and flow diagrams, and combinations of blocks in the block diagrams and flow diagrams, can be implemented by special-purpose, hardware-based computer systems that perform the specified functions, elements or steps, or combinations of special-purpose hardware and computer instructions.

The present invention may be embodied in other specific forms without departing from the spirit or essential attributes thereof, and it is therefore desired that the present embodiment be considered in all respects as illustrative and not restrictive. Many modifications and other embodiments of the payment method linked to a mobile number will come to mind to one skilled in the art to which this invention pertains and having the benefit of the teachings presented in the foregoing description and the associated drawings. Therefore, it is to be understood that the invention is not to be limited to the specific embodiments disclosed and that modifications and other embodiments are intended to be included within the scope of the appended claims. Although methods and materials similar to or equivalent to those described herein can be used in the practice or testing of the payment method linked to a mobile number, suitable methods and materials are described above. Thus, the payment method linked to a mobile number is not intended to be limited to the embodiments shown, but is to be accorded the widest scope consistent with the principles and features disclosed herein.

What is claimed is:

1. A method, comprising:
receiving a payment request from a payee device for a payment on behalf of payer;
determining, based on the payment request, a mobile number associated with the payer;
transmitting an authorization request for the payment to the mobile number;
receiving, responsive to the transmitting, a payment authorization from a device associated with the mobile number;
submitting a transaction request to a financial institution associated with the payer to make the payment to payee, wherein the financial institution is responsible for transferring funds from the payer to the payee based on the transaction request; and
notifying the payer and payee as to a result of the transaction request.

2. The method of claim 1, further comprising:
receiving, prior to the payment request, an enrollment request to enroll the payer in a mobile payment system;
assigning a payment identifier to the payer associated with the mobile phone number of the payer;
receiving financial information from the payer, wherein the financial information enables the mobile payment system to make a payment on behalf of the payer for a future purchase transaction; and
creating an association between the payment identifier and the received financial information.

3. The method of claim 1, wherein the payment authorization comprises a personal identification number (PIN) associated with the payer.

4. The method of claim 1, wherein the receiving the payment authorization comprises:
determining that the payment authorization includes a denial of payment, wherein in lieu of submitting the transaction request, the payer is notified that the payment request has been denied.

5. The method of claim 1, wherein the receiving the payment request, the transmitting the authorization request, and the receiving the payment authorization are all performed via SMS messaging.

6. The method of claim 5, wherein the payee device is not connected to the network, and wherein the payment request is received via a telecommunications network.

7. The method of claim 1, wherein the receiving the payment request comprises:
determining whether the payment request exceeds a payment threshold of the payer.

8. The method of claim 7, wherein if the payment request exceeds the payment threshold, notifying the payer and payee that the transaction has been denied.

9. The method of claim 1, wherein the receiving the payment request comprises:
receiving an enrollment request from the payer;
receiving financial information from the payer; and
configuring a payer device corresponding to the payer with a mobile payment configuration.

10. A system comprising one or more processors coupled to a non-transitory memory that are configured, when executed, to:
receive a payment request from a payee device for a payment on behalf of payer;
determine, based on the payment request, a mobile number associated with the payer;
transmit an authorization request for the payment to the mobile number;
receive, responsive to the transmitting, a payment authorization from a device associated with the mobile number;
submit a transaction request to a financial institution associated with the payer to make the payment to payee; and
notify the payer and payee as to a result of the transaction request.

11. The system of claim 10, wherein the one or more processors are further configured to:
receive, prior to the payment request, an enrollment request to enroll the payer in a mobile payment system;
assign a payment identifier to the payer associated with the mobile phone number of the payer;
receive financial information from the payer, wherein the financial information enables the mobile payment system to make a payment on behalf of the payer for a future purchase transaction; and
create an association between the payment identifier and the received financial information.

12. The system of claim 10, wherein the payment authorization comprises a personal identification number (PIN) associated with the payer.

13. The system of claim 10, wherein the one or more processors configured to receive the payment authorization are configured to:
determine that the payment authorization includes a denial of payment, wherein in lieu of submitting the transaction request, the payer is notified that the payment request has been denied.

14. The system of claim 10, wherein the one or more processors configured to receive the payment request, transmit the authorization request, and then receive the payment authorization are all configured to receive and transmit using SMS messaging.

15. The system of claim 14, wherein the payee device is not connected to the network, and wherein the payment request is received via a telecommunications network.

16. The system of claim 10, wherein the one or more processors configured to receive the payment request are configured to:
determine whether the payment request exceeds a payment threshold of the payer.

17. The system of claim 16, wherein if the payment request exceeds the payment threshold, the one or more processors are configured to notify the payer and payee that the transaction has been denied.

18. The system of claim 10, wherein the one or more processors configured to receive the payment request are configured to:
receive an enrollment request from the payer;
receive financial information from the payer; and
configure a payer device corresponding to the payer with a mobile payment configuration.

19. A computer program product tangibly embodied on a non-transitory computer readable medium that when executed by one or more processors, causes the one or more processors to:
receive a payment request from a payee device for a payment on behalf of payer;
determine, based on the payment request, a mobile number associated with the payer;
transmit an authorization request for the payment to the mobile number;
receive, responsive to the transmitting, a payment authorization from a device associated with the mobile number;
submit a transaction request to a financial institution associated with the payer to make the payment to payee; and
notify the payer and payee as to a result of the transaction request.
